(19) United States
(12) Patent Application Publication
(10) Pub. No.: US 2013/0145776 A1
(43) Pub. Date: Jun. 13, 2013

(54) AIR CONDITIONING CONTROL APPARATUS AND METHOD THEREOF

(71) Applicants: Hyundai Motor Company, Seoul (KR); Kia Motors Corporation, Seoul (KR)

(72) Inventors: Jae Woong Kim, Hwaseong-si (KR); Jaehyun Park, Gunpo-si (KR); Sang Hun Kim, Anyang-si (KR); Joon Hyung Park, Gunpo-si (KR)

(73) Assignees: Kia Motors Corporation, Seoul (KR); Hyundai Motor Company, Seoul (KR)

(21) Appl. No.: 13/692,656

(22) Filed: Dec. 3, 2012

(30) Foreign Application Priority Data
Dec. 7, 2011 (KR) 10-2011-0130338

(51) Int. Cl. B60H 1/32

(52) U.S. Cl. CPC B60H 1/3205
USPC 62/61; 62/133

(57) ABSTRACT

An air conditioning control apparatus and a method thereof may include an air conditioning control apparatus that controls the temperature of the interior of a vehicle may include an air-conditioning system including a condenser by condensing the refrigerant, an evaporator, a compressor, a heater core that controls the temperature of air flowing to the interior of the vehicle, a temperature control door that may be disposed between the evaporator and the heater core and controls flow of the heater core for the air passing through the evaporator, and a blower that blows the air flowing inside from the interior or the exterior of the vehicle to the evaporator, a sensor unit that includes an engine speed sensor measuring the number of revolutions of an engine and a throttle position sensor measuring the amount of opening of a throttle, and a controller that controls the operation of the air-conditioning system.

### CROSS-REFERENCE TO RELATED APPLICATION

The present application claims priority to Korean Patent Application No. 10-2011-0130338 filed on Dec. 7, 2011, the entire contents of which is incorporated herein for all purposes by this reference.

### BACKGROUND OF THE INVENTION

1. Field of the Invention

The present invention relates to an air conditioning control apparatus and a method thereof, and more particularly, an air conditioning control apparatus and a method thereof for a vehicle.

2. Description of Related Art

Recently, each country has strictly enforced regulations of exhaust gases and fuel efficiency to overcome global warming and exhaustion of the fuel source. It has been required to improve auxiliary components, including the power train, in order to improve fuel efficiency and one of the auxiliary components is an air-conditioning system including an air conditioner.

The air conditioning system includes a compressor and the compressor selectively receives power of an engine, which is transmitted through a pulley, by engagement/disengagement of an electronic clutch, sucks a refrigerant from an evaporator, and then discharges the refrigerant to a condenser. There are many kinds of compressors and a variable displacement compressor in them is widely used for vehicles.

According to the variable displacement compressor, as the pressure of a refrigerant is changed by a pressure control valve, the inclination angle of a swash plate can be controlled. The stroke distance of a piston is changed by controlling the inclination angle of the swash plate, so that the discharge capacity of the refrigerant can be controlled.

The compressor requires a large amount of driving force to operate. In particular, the compressor receives the driving force from a pulley coupled to a crankshaft by a belt, such that it is operated in accordance with the number of revolutions regardless of the cooling performance. Further, occupants operate the air-conditioning system to maintain a comfortable environment, such that the compressor may be unnecessarily operated and have bad influence on the fuel efficiency. This phenomenon frequently occurs in accelerating or decelerating.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an air conditioning control apparatus and a method thereof having advantages of preventing a compressor from unnecessarily operating in accelerating a vehicle.

An exemplary embodiment of the present invention provides an air conditioning control apparatus and a method thereof having advantages of reducing the amount of operation of a compressor, with the temperature of air, which is discharged into the interior from an air conditioning system, keeping constant.

In an aspect of the present invention, an air conditioning control apparatus that controls temperature in an interior of a vehicle, may include an air-conditioning system including a condenser that liquefies a refrigerant by condensing the refrigerant, an evaporator that evaporates a liquefied refrigerant, a compressor that compresses the refrigerant, a heater core that controls temperature of air flowing into the interior of the vehicle, a temperature control door that is disposed between the evaporator and the heater core and controls flow of the air passing through the evaporator into the heater core for, and a blower that blows air flowing inside from the interior or an exterior of the vehicle to the evaporator, a sensor unit including an engine speed sensor measuring revolution number of an engine, and a throttle position sensor measuring opening amount of a throttle, and a controller that controls operation of the air-conditioning system, wherein the control unit controls operation amount of the compressor by controlling air amount of flowing in the air-conditioning system, when an acceleration condition for the vehicle is generated.

The air-conditioning system may include a pair of temperature control doors disposed in front of the heat core and in rear thereof.

A discharge door is disposed in front of the heater core to control air passing through the evaporator or the heater core to flow to the interior of the vehicle.

An internal/external air door is disposed in rear of the evaporator to selectively control air flowing from the interior or the exterior of the vehicle.

The controller determines a reduction amount of a ratio rₕ of an air amount flowing into the heater core to an air amount flowing into the evaporator, when the acceleration condition is generated, and controls the air amount flowing in the air-conditioning system in accordance with the reduction amount of the ratio rₕ of the air amount flowing into the heater core to the air amount flowing into the evaporator.

The air amount flowing into the heater core is reduced in accordance with the reduction amount of the ratio rₕ of the air amount flowing into the heater core to the air amount flowing into the evaporator.

The air amount flowing into the heater core is reduced by controlling the temperature control door.

In another aspect of the present invention, a method of controlling an air-conditioning apparatus having an air-conditioning system including a condenser that liquefies a refrigerant by condensing the refrigerant, an evaporator that evaporates a liquefied refrigerant, a compressor that compresses the refrigerant, a heater core that controls a temperature of air flowing to an interior of a vehicle, a temperature control door that is disposed between the evaporator and the heater core and controls flow of the air passing through the evaporator into the heater core , an internal/external air door that controls internal air and external air to selectively flow inside the vehicle, and a blower that blows the air flowing inside the vehicle through the internal/external air door to the evaporator, may include determining whether an acceleration condition for the vehicle may have been generated, determining a reduction amount of a ratio rₕ of an air amount flowing into the heater core to an air amount flowing into the evaporator, when recognizing the acceleration condition, and reducing an operation amount of the compressor in accordance with the reduction amount of the ratio rₕ of the air amount flowing into the heater core to the air amount flowing into the evaporator.

The method may further include controlling the temperature control door in accordance with the reduction amount of the ratio rₕ of the air amount flowing into the heater core to the air amount flowing into the evaporator, when determining the reduction amount of the ratio rₕ of the air amount flowing into the heater core to the air amount flowing into the evaporator.

The air-conditioning system may include a pair of temperature control doors disposed in front of the heat core and in rear thereof.

A discharge door is disposed in front of the heater core to control air passing through the evaporator or the heater core to flow to the interior of the vehicle.

An internal/external air door is disposed in rear of the evaporator to selectively control air flowing from the interior or the exterior of the vehicle.

According to an exemplary embodiment of the present invention, it is possible to prevent the compressor from unnecessarily operating in accelerating a vehicle.

According to an exemplary embodiment of the present invention, it is possible to reduce the operation amount of the compressor, with the temperature of the air, which is discharged to the interior from the air-conditioning system, keeping constant.

According to an exemplary embodiment of the present invention, it is possible to improve the acceleration performance and fuel efficiency by reducing the operation amount of the compressor, so that it is possible too supply pleasant air to the interior.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram schematically illustrating an air conditioning control apparatus according to an exemplary embodiment of the present invention.

FIG. 2 is a diagram illustrating the air-conditioning system of FIG. 1.

FIG. 3 is a flowchart illustrating an air conditioning control method according to an exemplary embodiment of the present invention.

FIG. 4 is a table showing the relationship between the operation amount of a compressor and the ratio rₕ of the amount of air flowing into a heater core 45 to the amount of air flowing into an evaporator 43.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described more fully hereinafter with reference to the accompanying drawings, in which exemplary embodiments of the invention are shown.

The exemplary embodiments can be implemented in various different ways by those skilled in the art, as examples of the present invention, so it should be noted that the scope of the present invention is not limited to the following exemplary embodiments.

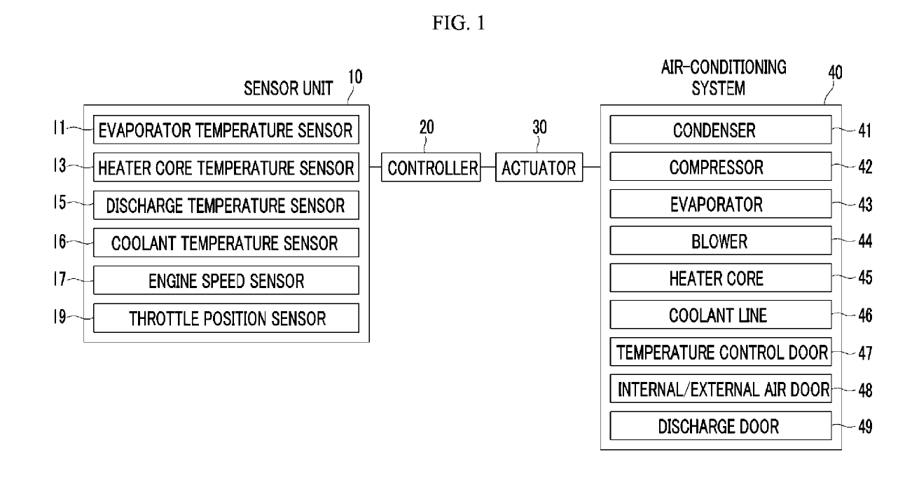

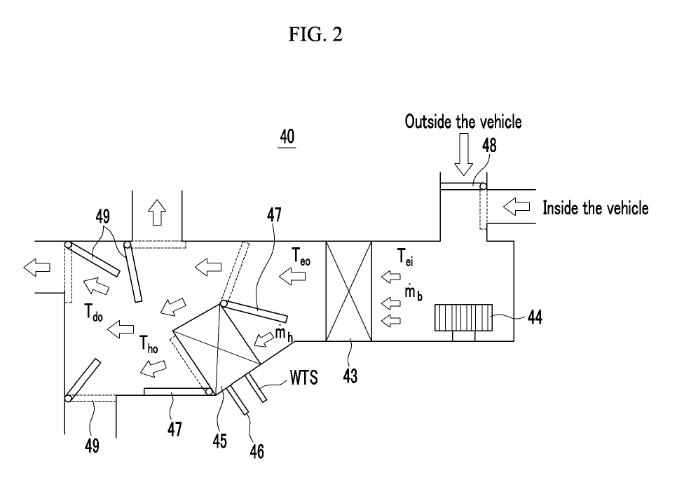

FIG. 1 is a block diagram schematically illustrating an air conditioning control apparatus according to an exemplary embodiment of the present invention and FIG. 2 is a diagram illustrating the air-conditioning system 40 of FIG. 1.

Referring to FIGS. 1 and 2, an air conditioning control apparatus includes a sensor unit 10, a controller 20, and actuator 30, and an air-conditioning system 40. The air conditioning control apparatus controls the operation amount of a compressor by control the amount of air in the air-conditioning system 40 when a vehicle is accelerated. In detail, the air conditioning control apparatus reduces the operation amount of the compressor by reducing the amount of air flowing into a heater core 45.

The sensor unit 10 includes an evaporator temperature sensor 11, a heater core temperature sensor 13, a discharge temperature sensor 15, a coolant temperature sensor 16, an engine speed sensor 17, and throttle position sensor 19. The sensor unit 10 may further include sensors (e.g., a vehicle speed sensor and a brake sensor) for shifting and/or sensors (e.g., an exhaust temperature sensor and an oxygen sensor) for controlling the engine.

The evaporator temperature sensor 11 measures the temperatures at the inlet and the exit of the evaporator 43 and transmits signals corresponding to the temperatures to the controller 20.

The heater core temperature sensor 13 measures the temperature at the exit of the heater core 45 and transmits a signal corresponding to the temperature to the controller 20.

The coolant temperature sensor 16 measures the temperature of a coolant flowing into the heater core 45 and transmits a signal corresponding to the temperature to the controller 20.

The discharge temperature sensor 15 measures the temperature of air discharging to the interior of a vehicle and transmits a signal corresponding to the temperature to the controller 20.

The engine speed sensor 17 measures the revolution speed of the engine from a change in phase of a crankshaft and transmits a signal corresponding to the temperature to the controller 20.

The throttle position sensor 19 measures the degree of opening of a throttle corresponding to the operation degree of an accelerator pedal and transmits a signal corresponding to the temperature to the controller 20.

The controller 20 is electrically connected to the sensor unit, so that it receives the signals corresponding to the values measured by the sensor unit 10 and controls the operation of the air-conditioning system 40 on the basis of the signals.

The actuator 30 is electrically connected to the controller 20 and operates the air-conditioning system 40 in response to a control signal transmitted from the controller 20. A solenoid device may be used as the actuator 30 and the control signal may be a duty signal that is supplied to the solenoid device.

The air-conditioning system 40 is a general term indicating all the devices that are used for heating, ventilating, cooling of the interior of a vehicle and includes a condenser 41, an evaporator 43, the heater core 45, a temperature control door 47, an internal/external air door 48, and a blower 44. The air-conditioning system 40 may further include various parts that are not described herein.

The condenser 41 liquefies a refrigerant by condensing it, the evaporator 43 evaporates the liquefied refrigerant, and the compressor 42 compresses the refrigerant.

The internal/external air door 48 selectively allows the internal air or the external air of a vehicle to flow inside and the blower 44 blows the air flowing inside through the internal/external air door 48 to the evaporator 43.

The heater core 45 controls the temperature of the air flowing to the interior of the vehicle. The heater core 45 is provided with a coolant line 46 for cooling the heater core 45.

The temperature control door 47 is disposed between the evaporator 43 and the heater core 45 and controls the flow of the heater core 45 for the air passing through the evaporator.

A discharge door 49 controls the air passing through the evaporator 43 and/or the heater core 45 to flow to the interior of the vehicle through the exit port.

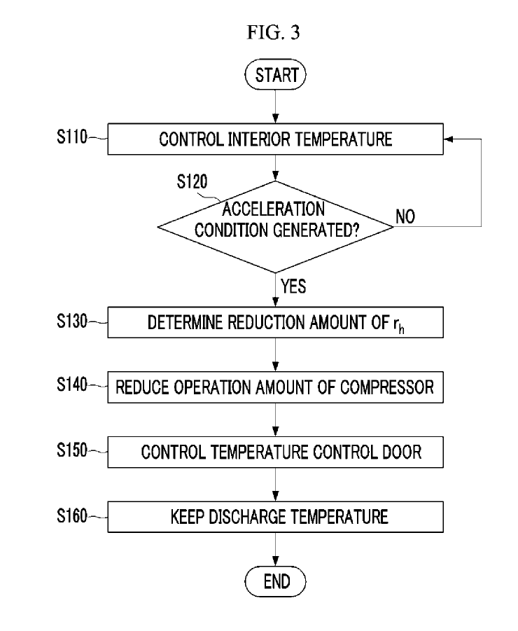

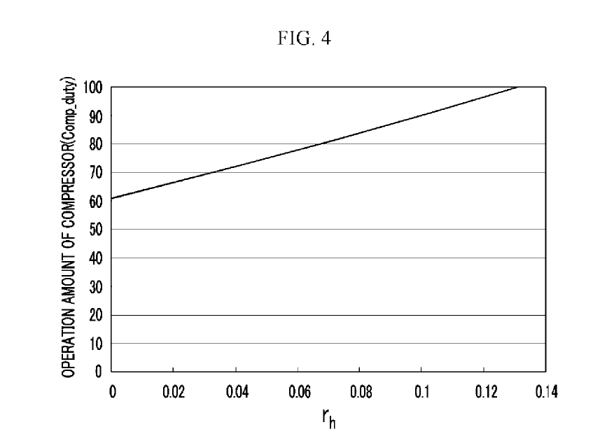

A method of controlling the compressor 42 for a vehicle, using the air conditioning control system, is described with reference to FIGS. 3 and 4.

FIG. 3 is a flowchart illustrating an air conditioning control method according to an exemplary embodiment of the present invention and FIG. 4 is a table showing the relationship between the operation amount of a compressor and the ratio rₕ of the amount of air flowing into a heater core 45 to the amount of air flowing into an evaporator 43.

FIG. 3 is a flowchart illustrating an air conditioning control method according to an exemplary embodiment of the present invention.

As illustrated in FIG. 3, the controller controls the interior temperature of a vehicle, when the vehicle is being driven (S110). The controller 20 determines whether acceleration conditions have been generated, in this status (S120). FIG. 3 shows acceleration conditions and acceleration stop conditions in acceleration modes. The acceleration conditions and acceleration stop conditions are set in a map to the number of revolutions of the engine and the amount of opening of the throttle. In an exemplary embodiment of the present invention, the controller 20 determines the acceleration mode, when the acceleration conditions are satisfied, in order to improve accuracy in controlling the compressor 42. The acceleration mode may include a rapid acceleration mode and a slow acceleration mode. Further, the acceleration mode may be divided in more detail, if necessary.

In S120, when an acceleration condition is not generated, the controller 20 keeps controlling the temperature of the interior (S110).

In S120, when an acceleration condition is generated, the controller 20 determines the reduction amount of the ratio rₕ of the amount of air flowing into the heater core 45 to the amount of air flowing into the evaporator 43 (S130).

As illustrated in FIG. 4, a predetermined relationship is defined between the operation amount of the compressor and the ratio rₕ (hereafter, indicated only by rₕ) of the amount of air flowing into the heater core 45 to the amount of air flowing into the evaporator 43. In detail, the discharge temperature of the air flowing to the interior keeps constant and rₕ decreases, in the air-conditioning system 40, the operation amount of the compressor correspondingly decreases.

The relationship is described by means of a simple equation, as an example.

As described above, rₕ is the ratio of the amount of air flowing into the heater core 45 to the amount of air flowing into the evaporator 43 is expressed by the following equation. In the following equation, \dot{m}ₕ is the amount of air flowing into the heater core 45 and \dot{m}_{b} is the amount of air flowing into the evaporator 43. The amount of air flowing into the evaporator can be considered as the flow rate of the entire air in the air-conditioning system 40.

$${r}_{h} = \frac{{\dot{m}}_{h}}{{\dot{m}}_{b}}$$

The relationship among the discharge temperature T_{do} of the air discharged to the interior from the air-conditioning system 40, the exit temperature Tₑₒ of the evaporator 43, and the exit temperature Tₕₒ of the heater core 45 is a follows.

T_{do}=(1−rₕ)Tₑₒ+rₕTₕₒ

The exit temperature Tₕₒ of the heater core 45 has the following relationship with the temperature WTS of the coolant supplied to the heater core 45 and the heat dissipation efficiency ε of the heater core.

Tₕₒ=Tₑₒ−ε(Tₑₒ−WTS)

The discharge temperature T_{do} of the air discharged to the interior of the vehicle is expressed by the following relationship with the exit temperature Tₑₒ of the evaporator 43, the exit temperature Tₕₒ of the heater core 45, the temperature WTS of the coolant supplied to the heater core 45, and the heat dissipation efficiency ε of the heater core.

T_{do}=(1−rₕ)Tₑₒ+rₕ(Tₑₒ−ε(Tₑₒ−WTS))

The operation amount Comp_duty of the compressor 42 is as follows, under the assumption that it is proportionally controlled. In the following equations, Tₑᵢ is the inlet temperature of the evaporator and Kₚ a proportional control constant.

Comp_duty=Kₚ(Tₑᵢ−Tₑₒ)

When arranged with respect to the exit temperature of the evaporator 43 and is substituted into the equation of the discharge temperature T_{do} of the air discharged to the duty interior, the equation of the operation amount Comp_duty of the compressor 42 is as follows.

$${T}_{do} = ( 1 - {r}_{h} ) ( \frac{Comp\_duty}{{K}_{p}} - {T}_{ei} ) + {r}_{h} ( \frac{Comp\_duty}{{K}_{p}} - {T}_{ei} - ɛ ( \frac{Comp\_duty}{{K}_{p}} - {T}_{ei} - WTS ) )$$

The equations are arranged as follows,

$${T}_{do} = ( 1 - {r}_{h} ɛ ) ( \frac{Comp\_duty}{{K}_{p}} - {T}_{ei} ) + {r}_{h} ɛ WTS$$

When arranged in an equation of the operation amount Comp_duty of the compressor, these are as follows.

$$Comp\_duty = {K}_{p} ( \frac{{T}_{do} - {r}_{h} ɛ WTS}{1 - {r}_{h} ɛ} + {T}_{ei} )$$

As can be seen from the equations, there is a predetermined relationship between Comp_duty and rₕ.

In detail, the air is discharged with a constant discharge temperature T_{do} to the interior of the vehicle, the operation amount of the compressor Comp _duty can be reduced by reducing rₕ.

Therefore, when the operation amount Comp_duty of the compressor reduces, it is possible to keep the temperature T_{do} of the air discharged to the interior of the vehicle constant by reducing the flow rate \dot{m}ₕ through the heater core 45, even if the exit temperature Tₑₒ of the evaporator 43 increases.

When the reduction amount of rₕ is determined, the controller 20 controls the operation amount to reduce in accordance with the reduction amount of rₕ (S140). Further, the controller 20 controls the temperature control door 47 positioned ahead of the heater core 45 in order to control the air flowing into the heater core 45 in accordance with the reduction amount of rₕ (S150). That is, the temperature control door 47 is controlled such that the amount of air flowing into the heater core 45 reduces.

Therefore, the method of controlling the compressor 42 not only reduces the operation amount of the compressor by reducing rₕ, but reduces the amount of air flowing into the heater core 45 too, so that the temperature of the air discharged to the interior of the vehicle is kept constant (S160). Therefore, it is possible to reduce the operation amount of the compressor even without increasing the desired temperature of the evaporator 43 and to keep the temperature of the air discharged to the interior constant without an increase.

In the exemplary embodiment, the method of controlling the compressor 42 keeps the temperature of the air discharged to the interior of the vehicle by reducing the operation amount of the compressor in accordance with the reduction amount of rₕ. However, the present invention is not limited thereto, and it is possible to keep the temperature of the air discharged to the interior of the vehicle by determining the reduction amount of the operation amount of the compressor and determining the reduction amount of rₕ. The reduction amount of rₕ and the reduction amount of the compressor 42 can be sequentially or simultaneously determined and controlled.

The method of controlling the compressor 42 according to the exemplary embodiment controls the amount of air flowing into the heater core 45 in accordance with the reduction amount of rₕ. However, the present invention is not limited thereto and it is possible to reduce rₕ by increasing the amount of the air flowing into the evaporator 43, that is, the amount of air in the entire air-conditioning system 40 or controlling the amount of the air flowing into the evaporator 43 and the amount of air flowing into the heater core 45.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air conditioning control apparatus that controls temperature in an interior of a vehicle, the apparatus comprising:
an air-conditioning system including:
a condenser that liquefies a refrigerant by condensing the refrigerant;
an evaporator that evaporates a liquefied refrigerant;
a compressor that compresses the refrigerant;
a heater core that controls temperature of air flowing into the interior of the vehicle;
a temperature control door that is disposed between the evaporator and the heater core and controls flow of the air passing through the evaporator into the heater core for; and
a blower that blows air flowing inside from the interior or an exterior of the vehicle to the evaporator;
a sensor unit including:
an engine speed sensor measuring revolution number of an engine; and
a throttle position sensor measuring opening amount of a throttle; and
a controller that controls operation of the air-conditioning system,
wherein the control unit controls operation amount of the compressor by controlling air amount of flowing in the air-conditioning system, when an acceleration condition for the vehicle is generated.

2. The apparatus of claim 1, wherein the air-conditioning system includes a pair of temperature control doors disposed in front of the heat core and in rear thereof.

3. The apparatus of claim 1, wherein a discharge door is disposed in front of the heater core to control air passing through the evaporator or the heater core to flow to the interior of the vehicle.

4. The apparatus of claim 1, wherein an internal/external air door is disposed in rear of the evaporator to selectively control air flowing from the interior or the exterior of the vehicle.

5. The apparatus of claim 1, wherein the controller
determines a reduction amount of a ratio rₕ of an air amount flowing into the heater core to an air amount flowing into the evaporator, when the acceleration condition is generated, and
controls the air amount flowing in the air-conditioning system in accordance with the reduction amount of the ratio rₕ of the air amount flowing into the heater core to the air amount flowing into the evaporator.

6. The apparatus of claim 5, wherein the air amount flowing into the heater core is reduced in accordance with the reduction amount of the ratio rₕ of the air amount flowing into the heater core to the air amount flowing into the evaporator.

7. The apparatus of claim 6, wherein the air amount flowing into the heater core is reduced by controlling the temperature control door.

8. A method of controlling an air-conditioning apparatus having an air-conditioning system including a condenser that liquefies a refrigerant by condensing the refrigerant, an evaporator that evaporates a liquefied refrigerant, a compressor that compresses the refrigerant, a heater core that controls a temperature of air flowing to an interior of a vehicle, a temperature control door that is disposed between the evaporator and the heater core and controls flow of the air passing through the evaporator into the heater core , an internal/external air door that controls internal air and external air to selectively flow inside the vehicle, and a blower that blows the air flowing inside the vehicle through the internal/external air door to the evaporator, the method comprising:
determining whether an acceleration condition for the vehicle has been generated;
determining a reduction amount of a ratio rₕ of an air amount flowing into the heater core to an air amount flowing into the evaporator, when recognizing the acceleration condition; and
reducing an operation amount of the compressor in accordance with the reduction amount of the ratio rₕ of the air amount flowing into the heater core to the air amount flowing into the evaporator.

9. The method of claim 8, further comprising controlling the temperature control door in accordance with the reduction amount of the ratio rₕ of the air amount flowing into the heater core to the air amount flowing into the evaporator, when determining the reduction amount of the ratio rₕ of the air amount flowing into the heater core to the air amount flowing into the evaporator.

10. The method of claim 8, wherein the air-conditioning system includes a pair of temperature control doors disposed in front of the heat core and in rear thereof.

11. The method of claim 8, wherein a discharge door is disposed in front of the heater core to control air passing through the evaporator or the heater core to flow to the interior of the vehicle.

12. The method of claim 8, wherein an internal/external air door is disposed in rear of the evaporator to selectively control air flowing from the interior or the exterior of the vehicle.
